(19) United States
(12) Patent Application Publication
(10) Pub. No.: US 2010/0134272 A1
(43) Pub. Date: Jun. 3, 2010

(54) Helmet Providing Driving Instructional Signals

(76) Inventor: Alfred J. Palacios, Hawthorne, CA (US)

Correspondence Address: Robert J. Schaap, P.O. Box 950103, Mission Hills, CA, 91395, US

(21) Appl. No.: 12/434,631

(22) Filed: May 2, 2009

Related U.S. Application Data
(60) Provisional application No. 61/119,715, filed on Dec. 3, 2008.

(51) Int. Cl. B60Q 1/34

(52) U.S. Cl. 340/475

(57) ABSTRACT

A helmet adapted for use with motorized non-enclosed vehicles and particularly motorcycles, and which helmet is capable of providing signal indicating lights, such as a braking light or left or right turn signal lights contemporaneously with the generating of such lights on the vehicle. In one embodiment of the invention, the helmet may be electrically connected to the wiring harness of the vehicle or generating the braking lights or left or right turn signal lights in relationship to those of the motorcycle. In another embodiment, the lights on the helmet may be operated through a transceiver arrangement contemporaneously with those on the motorcycle or similar vehicle.

### RELATED APPLICATIONS

This application is based on and claims for priority the filing date of my U.S. provisional patent application 61/119,715 filed Dec. 3, 2008, the full contents of which are incorporated herein by reference.

### BACKGROUND OF THE INVENTION

1. Field of the Invention

This invention relates in general to certain new and useful improvements in safety helmets to be worn by a passenger or a driver on a motorcycle or similar non-enclosed wheeled vehicle. More particularly the invention relates to such helmets which have on the rear surface thereof, indicator lights such as braking or directional turn indicator lights which may be operated contemporaneously on or in other timed relationship to the signal indicating lights on the motorcycle or other non-enclosed vehicle.

2. Brief Description of Related Art

Motorcycles and similar two wheeled powered vehicles and even three wheeled motorcycles and the like have become quite popular in recent years due to the fact they are more capable of traveling long distances while using only a relatively small amount of expensive fuel compared to that used by normal passenger automobiles. In addition there is also a widespread interest in the four wheeled motorcycles and even small utility vehicles which have no enclosed passenger compartment, sometimes referred to as a “non-enclosed vehicles”.

These non-enclosed vehicles are small, easy to park and highly maneuverable. In addition, several motorcycles can be parked in the same space normally occupied by one passenger automobile. However, motorcycles and other non-enclosed vehicles do present some risk when driving in normal traffic, along with passenger automobiles. Frequently, some drivers of passenger automobiles do not necessarily observe motorcycles and the drivers and passengers of the motorcycles. As a result, accidents do happen and since there is no cage-like metal protecting frames surrounding the occupants, injuries can be more severe and more frequent.

Due to the higher degree of risk associated with the riding of a motorcycle, many occupants of motorcycles will wear motorcycle helmets to at least protect the head of the occupant in the event of an injury or other fall from the vehicle. In fact, many countries have even mandated the use of certain motorcycle helmets in order to reduce the risk and the number of injuries and casualties associated with riding on a motorcycle.

In an effort to make the occupants of a motorcycle more visible, there have been many proposals for using flashing lights on the rear of the helmet. These flashing lights are usually in the form of light emitting diodes which are permanently mounted on the rear surface of the helmet. The flashing lights can be operated by a battery source of power carried in the helmet or otherwise by some hard wired mechanism to the wiring harness of the motorcycle or similar vehicle.

There are numerous examples of various arrangements for enabling warning lights on a helmet to be energized sequentially for causing a flashing of the lights on the helmet. However, heretofore and while there have been several attempts to provide motorcycle driver helmets having flashing warning lights, there has not been any effective attempt to provide a helmet with lights which are energized in timed relation to the lights of the motorcycle itself in order to make the intended driving actions of the motorcycle more prominent to other drivers.

Representative of those prior art references which show the use of flashing warning lights on a helmet are U.S. Pat. No. 5,313,187 to Choi et al., U.S. Pat. No. 7,128,434 to Nally et al. and U.S. Pat. No. 5,544,027. It would be desirable, however, to provide a helmet in which lights are located on a rear portion of the helmet and which operate to provide warning signals by the driver of the motorcycle in addition to those presently used on the motorcycle. This would, in turn, make the presence of the motorcycle and particularly the occupants of that motorcycle to be more visible and hence more prominent.

### OBJECTS OF THE INVENTION

It is, therefore, one of the primary objects of the present invention to provide a motorcycle helmet or other helmet for non-enclosed vehicles in which lights on rear portion thereof can be energized to provide warning signals of braking action or intended turning action of the driver and which would be more visible than those on the vehicle alone.

It is another object of the present invention to provide a motorcycle helmet of the type stated in which warning lights could be releasably attached to a rear surface of the motorcycle helmet.

It is a further object of the present invention to provide a helmet for use with motorcycles and similar non-enclosed vehicles in which a light on the helmet and can be operated in timed relationship to a light on the motorcycle or similar vehicle.

It is an additional object of the present invention to provide a helmet capable of providing electrically energized lights on the rear surface of that motorcycle helmet to be operated in conjunction with warning lights on a motorcycle and which also provides indication of the presence of the occupants of a motorcycle even when the warning lights are not operated.

It is another salient object of the present invention to provide a motorcycle helmet of the type stated which can be manufactured at a relatively low cost thereby enabling the wide spread use of such helmets and easy affordability of such helmets and which helmets are highly effective in use.

With the above and other objects in view, my invention resides in the novel features of form, construction, arrangement and combination of parts and components presently described and pointed out in the claims.

### BRIEF SUMMARY OF THE INVENTION

A for helmet for motorcycle and similar non-enclosed vehicles having electrically operated lights on a rear portion thereof, thereby enabling warning signals to be generated on the helmet of a driver or occupant of the vehicle in pre-timed relationship to any signal lights on the motorcycle or other vehicles. In addition, and in the event that the motorcycle is not equipped with warning lights, then the warning lights on the helmet will provide a highly effective substitute therefore. For brevity, the helmet will be referred to as a “motorcycle helmet”, although it will encompass all non-enclosed vehicle helmets.

In one embodiment of the invention, the warning lights on the rear surface of the motorcycle helmet could also be operated so as to provide indication of the mere presence of the occupant or occupants of a motorcycle. Thus, the lights on the rear portion of the helmet could be energized in a flashing arrangement and for that matter any type of flashing sequence, and they may also be operated to provide warning signals such as an intended braking action or a turning action by the driver of the vehicle. Thus, as a simple example, the warning lights could be operated in a flashing mode until such time as the driver of the vehicle displayed a turn signal or an intended braking action by engaging the brakes of the vehicle, or otherwise by turning on the left or right turn signal indicator lights on the vehicle.

In one embodiment of the invention, the lights on the rear surface of the motorcycle helmet can be electrically connected to the electrical wiring of the motorcycle. Thus, those conductors which provide energizing signals to the rear lights on the motorcycle could be electrically connected to light conductors on the inside of the motorcycle helmet. In another embodiment, and in order to avoid the use of electrical wires extending from the motorcycle to a user of the helmet, a transceiver arrangement can be provided. This transceiver arrangement would allow for a transmitter associated with the motorcycle to transmit signals to a receiver in or associated with the motorcycle helmet to thereby enable the generation of lights at the rear portion of the motorcycle helmet.

In addition to the foregoing, the invention provides a unique method allowing the energizable light to be releasably mounted on the rear surface of the helmet. In this way, it is not necessary to physically mount the lights on the helmet and moreover, any helmet could be readily adapted for use with the present invention. In this embodiment, the lights could be releasably mounted on a flexible substrate which could be attached to the helmet by fiber fastening straps, adhesives or the like.

Many helmets usually are provided with interior straps to cushion the helmet from direct contact with the exterior surface of the hard outer shell forming part of the helmet. Thus, in this case, a receiver could literally be mounted in the helmet between this hard shell and the interior straps. It should also be recognized that the lights and particularly a substrate, e.g. a circuit board, on which the lights are mounted, can be permanently secured to or literally formed within the shell of the helmet.

This invention possesses many other advantages and has other purposed which may be made more clearly apparent from a consideration of the forms in which it may be embodied. These forms are shown in the drawings forming a part of an accompanying the present specification. They will now be described in detail for purposes of illustrating the general principles of the invention. However, it is to be understood that the following detailed description and the accompanying drawings are not to be taken in a limiting sense.

### BRIEF DESCRIPTION OF THE DRAWINGS

Having thus described the invention in general terms, reference will now be made to the accompanying drawings (three sheets) in which:

FIG. 1 is a rear elevational view of a motorcycle helmet in accordance with the present invention and showing braking signal and turn signal indicator lights thereon;

FIG. 2 is a rear elevational view of a motorcycle helmet in accordance with the present invention and showing a schematic wiring diagram therefore;

FIG. 3 is a rear elevational view of a conventional motorcycle and showing a schematic connection of the vehicle rear turn signal and braking signal indicator lights to signal indicator lights on a rear portion of a helmet in accordance with the present invention;

FIG. 4 is an exploded perspective view showing a means for releasably attaching signal indicator lights to a rear portion of a helmet in accordance with the present invention;

FIG. 5 is a fragmentary side elevational view showing the application of signal indicator lights to the rear portion of a motorcycle helmet in accordance with the present invention;

FIG. 6 is a schematic wiring diagram showing the major components of an electrical circuit used for energizing the lights on a rear portion of a motorcycle helmet;

FIG. 7 is a schematic electrical circuit diagram showing a modified form of circuit for operatively connecting portions of the motorcycle electrical circuitry with signal indicator lights on a rear portion of a motorcycle helmet in accordance with the presence invention.

FIG. 8 of a helmet which may be made as an integral and complete unit with light emitting elements mounted thereon;

FIG. 9 is a vertical sectional view which illustrates another embodiment of a helmet 110 with light emitting elements on a rear surface thereof.

FIG. 10 illustrates a further embodiment of a helmet in accordance with the present invention in which an integrated circuit arrangement is mounted on an insert of the helmet;

FIG. 11 is a rear elevational view of an interior surface of that insert of FIG. 10, essentially taken along line 11-11 of FIG. 10; and

FIG. 12 illustrates an embodiment of the invention in which there are recesses for receiving light emitting diodes.

### DETAILED DESCRIPTION OF PREFERRED EMBODIMENTS

Referring now in more detail and by reference characters to the drawings, which illustrate preferred embodiments of the present invention, 10 designates a motorcycle helmet which may be of any standard shape and formed of those materials used in the formation of conventional motorcycle helmets. The motorcycle helmet would typically be provided with interior padding (not shown) and a neck strap 12 or the like.

Mounted on the rear surface of the motorcycle helmet is a brake light 14 and directional signal indicators 16 and 18. The directional signal indicator light 16 has the shape of an arrow to identify a left turn signal and the right hand signal indicator 18 has the shape an arrow pointing to the right to designate a right turn signal.

In connection with the present invention, it should be understood that any suitable designation could be used. For example, in the embodiment of the invention as illustrated, lights such as light emitting diodes 20, are mounted within the arrow 16 and light emitting diodes are also mounted in the arrow 20. Moreover, in the embodiment of the invention as shown, there is a separate brake light 14. However, it should be understood that a sequence of lights could be provided in place of an arrow or the like. It is only necessary to provide indication to other drivers or pedestrians that the driver is intending to make a turn or brake the speed of the motorcycle.

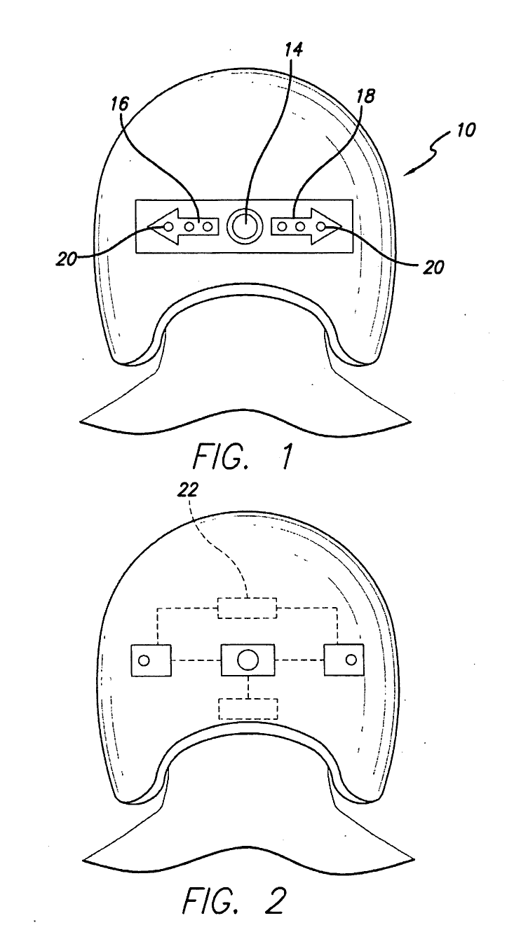

In the embodiment of the invention as shown in FIGS. 1 and 2, it can be seen that there is a control circuit 22 which may be mounted on or within the motorcycle helmet. This control circuit would be connected to the electrical circuit of the motorcycle, and particularly, that portion of the motorcycle which controls turn signals and braking signal lights. Again, the circuit 22 could also be in the form of a transceiver arrangement so as to pick up wireless signals from the motorcycle, as hereinafter described.

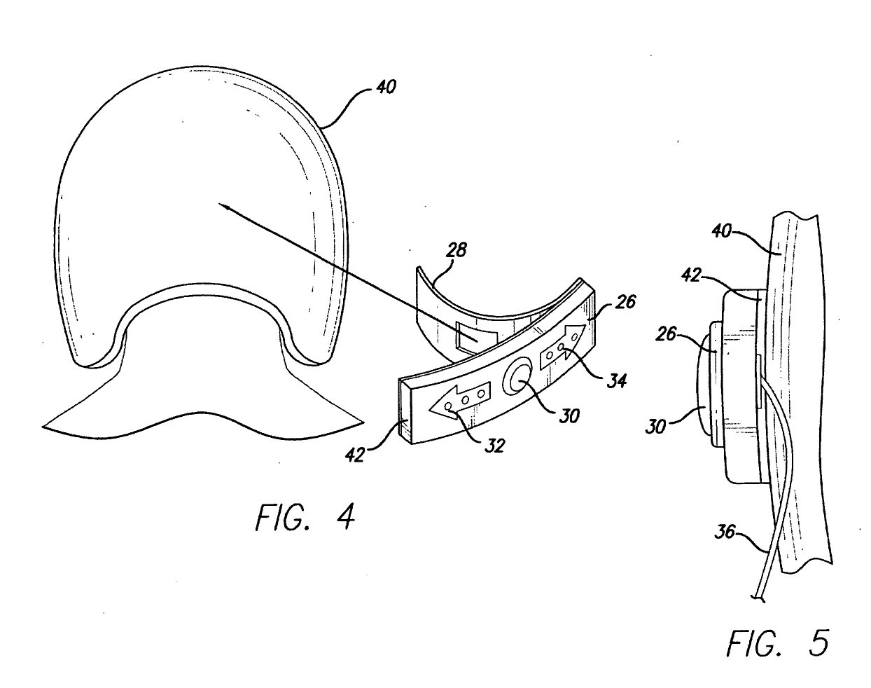

In the embodiment of the invention as shown in FIG. 4, there is provided a removably mounted substrate 26 having a release tape 28 covering an adhesive surface on the rear side of the substrate 26. Moreover, signal lights, such as a brake light 30 and directional indicator lights 32 and 34 are also mounted on the substrate 26. In addition, a wire (not shown) could be connected to the circuit arrangement of the motorcycle which controls these lights or otherwise, that circuit arrangement could be provided with a receiver for operating lights in accordance with signals from a remote transmitter.

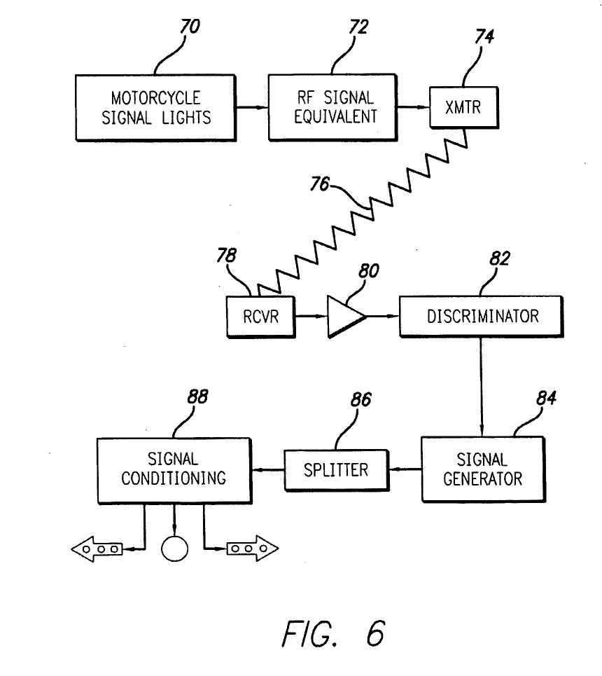

In the embodiment of the invention as shown in FIG. 5, there is provided a wire 36 which may be connected to the circuit of the motorcycle. However, again, as indicated above, this circuit could be operatively connected to the vehicle by means of a transceiver arrangement. Nevertheless, it can be seen that there can be a helmet 40 and mounted on the rear surface of the substrate 26 is the release paper 28 and which extends over an adhesive section 42.

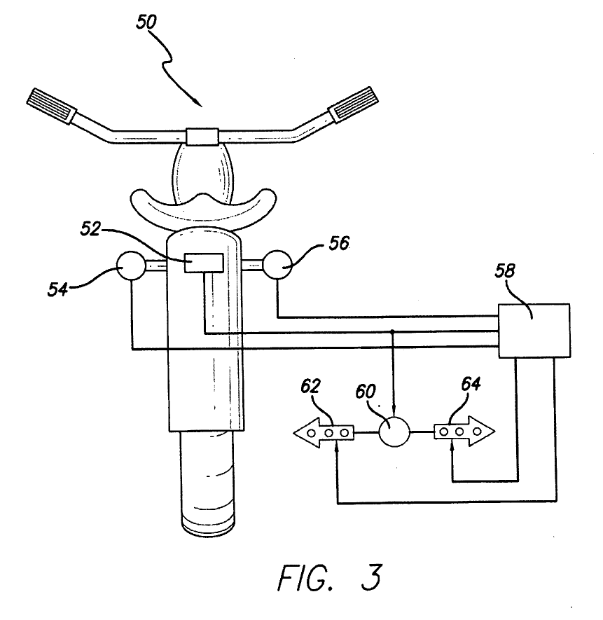

FIG. 3 illustrates a hard-wired version of the auxiliary light system used on a helmet and which illustrates a motorcycle 50 having a rear brake light 52 and a left turn signal indicator light 54, as well as a right turn signal indicator light 56. These various lights are shown as being electrically connected by hard wires to a control circuit 58. That control circuit forming part of the vehicle is connected to a terminal on a brake light whereas the signals to the brake lights 54 and 56 are delivered to arrow turn indicators 62 and 64 respectively. In this way, the helmet of the rider on the vehicle will display the same braking and turn signals which are also simultaneously displayed on the lights of the vehicle. However, since the helmet on a rider has a much higher profile, it will be more readily seen by others in the vicinity of the motorcycle.

FIG. 6 illustrates an embodiment of the invention which provides a circuit using a transceiver arrangement. In this case, the circuit will illustrate motorcycle signal lights 70 including, for example, the brake light and directional signal turn lights. These lights will generate light signals from the circuit of the motorcycle and will also generate equivalent radio frequency signals at 72. Any suitable circuit, such as a radio frequency circuit could be used to generate these signals. Obviously, one signal would be generated for a brake light, another signal generated for left turn signal indicator lights and a third signal for right turn signal indicator lights.

The radio frequency signal circuit 72 would be connected to a transmitter 74 which would, in turn, send a radio frequency signal 76 to a remote receiver 78. That remote receiver would be on the helmet of the motorcycle rider.

When a signal is received from the motorcycle, at the receiver, 78, it will be amplified through an amplifier 80 and introduced into a discriminator 82. This discriminator will determine the type of signal which is received, as for example, a left turn signal, a right turn signal or a stopping signal. The signal from the discriminator is then sent to a signal generator 84 and the splitter 86. The generator will generate a signal suitable for the use by the lights on the helmet. The signals would then be split at the splitter 86 and transmitted to a signal, conditioner 88. The signals are thereupon sent to the brake lights and the turn signal, lights on the helmet.

It should be understood that the circuit arrangement as illustrated in FIG. 6 is only one form of circuit arrangement which could be used for accomplishing this result. In effect, any circuit arrangement which receives a non-hard wired signal, such as a radio frequency signal, or the like could be used to transmit a signal from the motorcycle to the helmet.

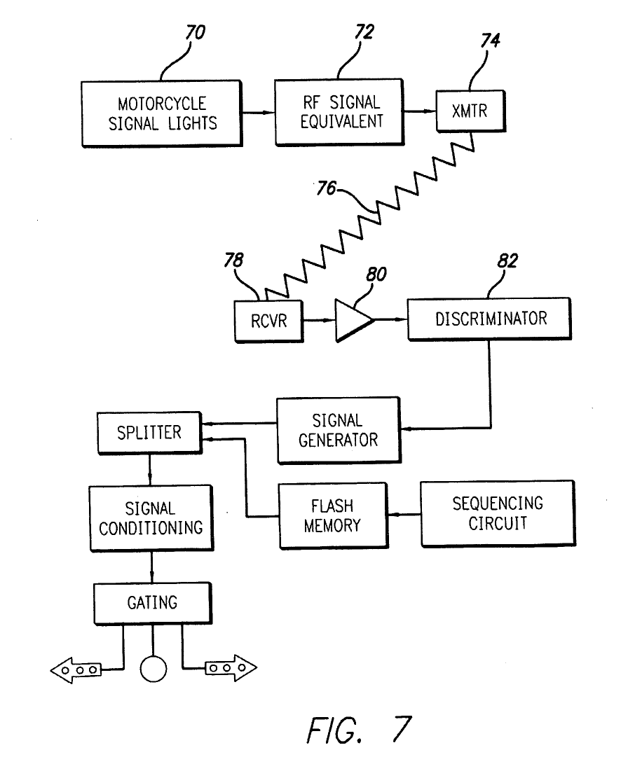

FIG. 7 is schematic electrical circuit diagram showing a modified form of circuit for operatively connection portions of the motorcycle electrical circuitry with signal indicator lights on a rear portion of a motorcycle helmet in accordance with the present invention

FIG. 7 essentially illustrates a further embodiment of the invention in which there is a constant sequencing of light energization of lights on the helmet so as to provide a flashing of the lights, which will alert others to the presence of the motorcycle, as well as to provide control signals, such as a braking signal or turn signals. Thus, and in this embodiment of the invention, the lights on the helmet regardless of whether they are directional indicator lights or not, may receive electrical signals for flashing of the lights. In this way, occupants of other vehicles and even pedestrians will readily notice the motorcycle and its occupants. In addition, and in the embodiment of the invention in FIG. 7, there will also be operating signals transferred to the lights on the helmet as well as the lights on the motorcycle.

The circuit of FIG. 7 is similar to the circuit of FIG. 6 and hence, reference numerals used in the circuit of FIG. 6 will also be used in the circuit of FIG. 7 to designate like components. In the circuit of FIG. 7, there is an exclusive OR gate 100 which receives the operating control signals from the motorcycle, typically by a transceiver arrangement, described in connection with the circuit of FIG. 6. In addition, there is a sequencing circuit 102 which will cause a generation of all of the lights in an “off” and “on” pattern so as to alert others to the presence of the motorcycle even when no operating signals are generated.

A flash memory may also be used for this purpose. There may also be a memory circuit 104 which causes the lights to generate in a specific pattern or in other pre-programmed patterns. This flash memory will enable any of a plurality of sequencing programs to cause a plurality of light signal patterns to be generated when the operating control signals are not used for generating the lights for brake signals or directional turn signals. It should be understood that any form of memory could be used in place of the flash memory.

It is also possible to locate the light assembly under a colored lens as for example, a red colored lens. In this way, the lights will be more visible to traffic to the rear of the motorcycle, or other vehicles. In like manner, it is possible to use a plurality of light emitting diodes or other light emitting elements for each of the instructional signals to be given. Thus, the left light indicator could be comprised of three light emitting elements, the right light indicator would be comprised of three elements and the breaking light would cause an energization of e.g., three or more neon lights.

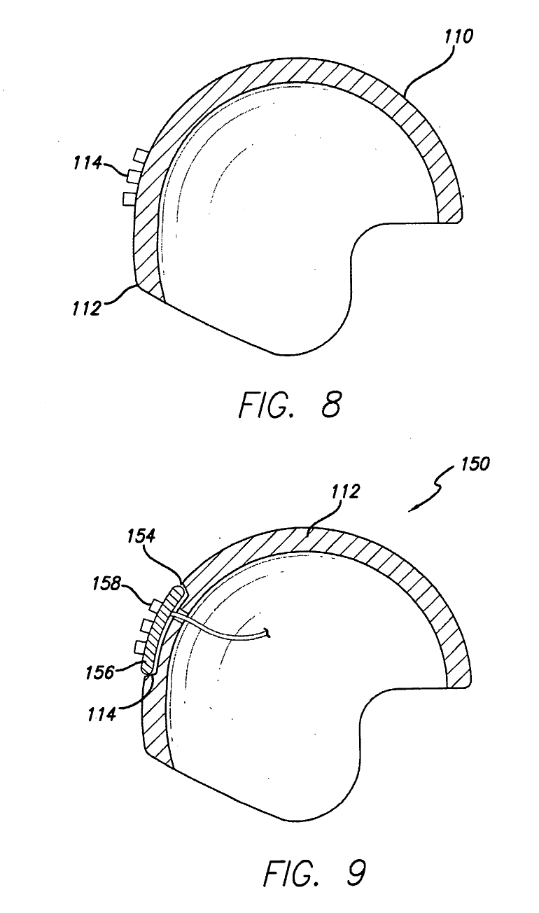

FIG. 8 illustrates an embodiment of a helmet which may be made as an integral and complete unit. In FIG. 8, there is provided a helmet 110 and which is provided on a rear surface 112 thereof with indicator lights such as light emitting diodes 114. The helmet could be constructed as a single unit, as indicated, and with the light emitting diodes actually molded into the helmet 110 in the formation thereof. Otherwise, if desired, a producer of the helmet could easily mount the light emitting diodes in openings in the helmet, after formation thereof. Any means for forming the helmet and insuring the presence of light emitting diodes 104, or other light indicator elements, could be employed for this purpose.

FIG. 9 illustrates an embodiment of a helmet 150 having a helmet shell 152 with a recessed portion 154 on a rear surface thereof. An insert is 116 is provided for disposition in that recess 154 and will essentially adopt the shape of the recessed portion 154. Moreover, the insert 156 could have on a surface thereof, a circuit board which provides for the lighting of various light emitting diodes 158 the rear surface of the inset 156. The insert could be provided with an integrated circuit such as a printed integrated circuit board.

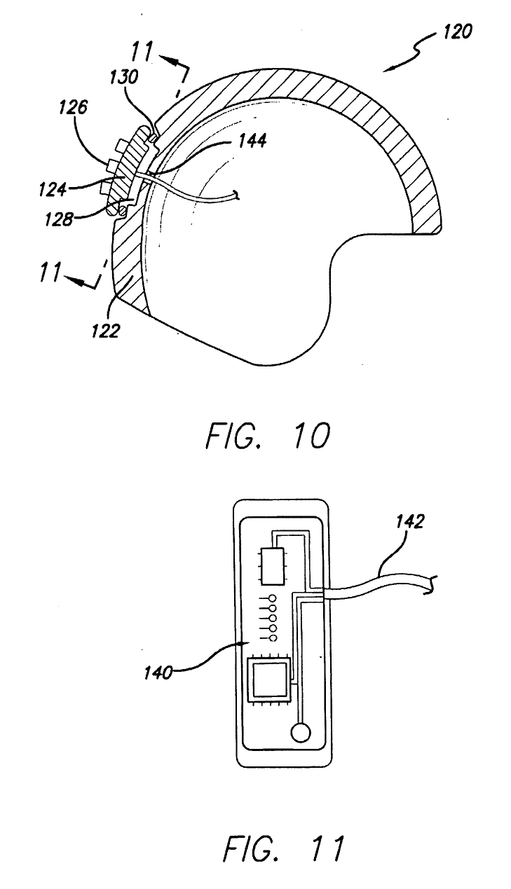

FIG. 10 illustrates a further embodiment of a helmet 120 in accordance with the present invention. In this case, there is a helmet shell 122 along with an insert 124. A circuit could be printed on the rear surface of that insert and light emitting diodes or other light elements 126 could be mounted on the front portion thereof. Moreover, this insert could be actually inserted into a recess 128 formed on a rear portion of the helmet and which is sized to receive that insert. The actual securement of the insert to the helmet could take place by use of an adhesive 130 or any other means permanently securing the insert in place. One preferred embodiment uses over-molding. Thus, the insert and the helmet shell 120 could be formed in separate molding operations. Thereafter, in an over-molding operation, the insert could be molded to the shell of the helmet and thereby permanently secure the insert as a permanent part of the helmet. Otherwise an adhesive 130 could be used to secure the insert to the helmet shell, as shown in the embodiment of FIG. 10.

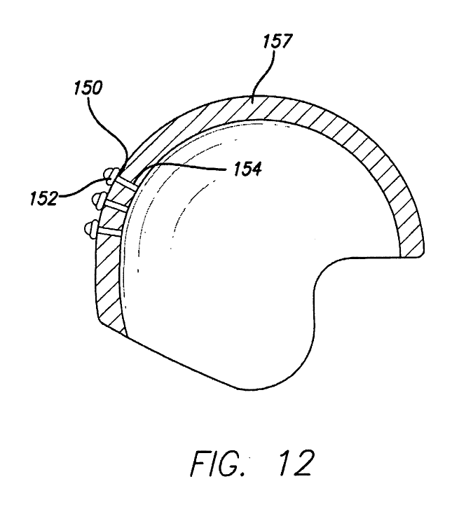

It can be seen that a printed circuit 140 could exist on the rear surface of the insert 116 or the rear surface of the insert 124. This printed surface could be formed in a conventional manner and would constitute that circuitry necessary for operation of the light emitting diodes or other lights on the insert. It can also be seen by reference to FIG. 10 and reference to FIG. 11 that there is a connecting wire 142 for connection to a circuit of the vehicle, such as the motorcycle. In this way, the light emitting diodes or other lights on the helmet would be energized in sequence to the lights on the motorcycle or other vehicle.

It can also be observed that a very small wire receiving aperture 144 can be formed in the helmet, as shown in FIG. 11, in order to receive a wire for connection to the electrical circuitry of the vehicle.

FIG. 12 illustrates an embodiment of the invention in which there are a plurality of recesses 150 for receiving the base portions of light emitting diodes 152. These recesses also communicate with apertures 154 extending through the shell of a helmet 156 for receipt of the connecting wires and the like. A more automated assembly system could be used for replacing light emitting diodes in the recesses 150 and permanently mounting lights in such recesses.

Thus, there has been illustrated and described a unique and novel safety helmet light signaling system, and which thereby fulfills all of the objects and advantages which have been sought. It should be understood that many changes, modifications, variations and other uses and applications which will become apparent to those skilled in the art after considering the specification and the accompanying drawings. Therefore, any and all such changes, modifications, variations and other uses and applications which do not depart from the spirit and scope of the invention are deemed to be covered by the invention.

Having thus described the invention, what I desire to claim and secure by Letters Patent is:

1. A safety helmet light signal system used in connection with motorcycles and like two wheel and three wheel vehicles having no safety cage structure but which have a rear light signaling system, said light signaling system comprising:
a) a plurality of lights on a rearwardly presented surface of a safety helmet normally worn by an occupant when the motorcycle or like vehicle is being driven:
1) two of said lighting elements being offset from a center position of said helmet toward sides of said helmet and providing indication of turn signals on said motorcycles, each one of said two lighting elements on said helmet being energized to indicate a potential right turn or left turn in timed relationship to energization of a left turn or right turn signal light on the vehicle.

2. The light signaling system of claim 1 further characterized in that said helmet further comprises:
a) an additional lighting element to provide indication of a brake light corresponding to a brake light of the vehicle and which is energized in timed relation to the energization of the brake light of the vehicle.

3. The light signaling system of claim 1 further characterized in that said two of said lighting elements comprises:
a) an outer shape such that one of said light elements indicates a turn to the right and the other of the light elements indicates a turn to the left.

4. The light signaling system of claim 3 further characterized in that said each of said light elements are arrow-shaped.

5. The light signaling system of claim 1 further characterized that said lighting elements on said helmet are electrically connected to turn indicating lights on the vehicles by electrical wires.

6. The light signaling system of claim 1 further characterized in that said lighting elements on said helmet are operatively connected to turn lights on the vehicle through a non hard wired transmitter and receiver arrangement.

7. The light signaling system of claim 1 further characterized in that said lighting elements on said helmet are mounted directly to said helmet on a rear surface thereof.

8. The light signaling system of claim 1 further characterized in that said lighting elements on a surface of said helmet being operatively secured to a substrate which is adapted for operative securement to a surface of said helmet.

9. The light signaling system of claim 8 further characterized in that said light signaling system further comprise:
a) means for energizing said lighting elements on said helmet.

10. A light alerting and signaling system for use on a safety helmet namely a helmet adapted for use with motorcycle riders and altering a signaling system comprising:
a) a plurality of directional turn lights on said helmet for altering drivers of other vehicles about an intended turn of the motorcycle to the right or left;
b) at least one stop altering light on said helmet for altering drivers of other vehicles about a slowing or stopping of the motorcycle; and
c) means for causing a flashing of one or more of said light when the lights do not provide indication of an intended turn or a slowing or stopping to alert drivers of other vehicles about the presence of the motorcycle.

11. The light alerting and signaling system of claim 1 further characterized in that:
a) said lights comprise light emitting diodes.

12. The light signaling system of claim 10 further characterized that said lights on said helmet are electrically connected to turn indicating lights on the motorcycle by electrical wires.

13. The light signaling system of claim 1 further characterized that said lights on said helmet are operatively connected to turn lights on the motorcycle through a non-hard wired transmitter and receiver arrangement.

14. A method for duplicating a driving instructional signal used on a motorcycle and like vehicle, said method comprising:
a) providing a plurality of lights on a rear surface of a safety helmet worn by an occupant of said vehicle;
b) main signaling means associated with said vehicle for directing driving instructional signals to rear lights on said vehicle and advising the public to the rear of a vehicle of an intended turning action or stopping of the vehicle; and
c) auxiliary signaling mean for changing driving instructional signals to sequential flashing light signals to be delivered to the lights on the rear surface of said helmet.

15. The method of duplicating a driving instructional signal of claim 14 further characterized that said method further comprises:
a) means connection to the said light auxiliary signaling means to the lights on the rear of the vehicle by hard wires such that the instructional signals are electrically connected to said lights by electrical wires.

16. The method of duplicating a driving instructional signal of claim 14 further characterized that said method further comprises:
a) enabling communication between said auxiliary signaling means to the lights on a rear of the vehicle by electrical hard wired instructional signals using a non wire signal transceiver arrangement.

17. A helmet capable of emitting light signals for use with motorcycles and like non-enclosed vehicles, said helmet comprising:
a) an outer shell for disposition over a head of a user and having a front portion and a rear portion thereon;
b) an opening on a rear portion of said helmet sized to receive an insert thereon;
c) an insert provided for disposition over said opening; and
d) a circuit on said insert including light generating elements which are capable of being energized to generate driver intended vehicle actions.

18. The helmet of claim 17 further characterized in that said light generating elements are light emitting diodes.
